(19) United States
(12) Patent Application Publication
(10) Pub. No.: US 2020/0185788 A1
(43) Pub. Date: Jun. 11, 2020

(54) ELECTRODES HAVING ELECTRODE ADDITIVE FOR HIGH PERFORMANCE BATTERIES AND APPLICATIONS OF SAME

(71) Applicants: Ford Cheer International Limited, Road Town (VG); The Regents of the University of California, Oakland, CA (US)

(72) Inventors: Jianguo Xu, Walnut, CA (US); Yunfeng Lu, Culver City, CA (US); Li Shen, Los Angeles, CA (US)

(21) Appl. No.: 16/787,247

(22) Filed: Feb. 11, 2020

Related U.S. Application Data
(63) Continuation-in-part of application No. 15/888,223, filed on Feb. 5, 2018.
Application No. 15/888,223 is a continuation-in-part of application No. 15/888,232, filed on Feb. 5, 2018.
Application No. 15/888,232 is a continuation-in-part of application No. 16/369,031, filed on Mar. 29, 2019.
(60) Provisional application No. 62/803,725, filed on Feb. 11, 2019.
(60) Provisional application No. 62/455,752, filed on Feb. 7, 2017.
(60) Provisional application No. 62/455,800, filed on Feb. 7, 2017.
(60) Provisional application No. 62/455,752, filed on Feb. 7, 2017.
(60) Provisional application No. 62/455,800, filed on Feb. 7, 2017.
(60) Provisional application No. 62/650,580, filed on Mar. 30, 2018.
(60) Provisional application No. 62/650,623, filed on Mar. 30, 2018.

(51) Int. Cl. H01M 10/42; H01M 4/62

(52) U.S. Cl. CPC H01M 10/4235; H01M 4/625; H01M 4/623

(57) ABSTRACT

The invention provides a general type of porous coordination solids, metal-organic frameworks (MOFs), as an electrode additive to improve thermal stability, rate and cycle performances of batteries, and an electrode having the electrode additive. The incorporation of the MOF additive into the electrode is fully compatible with current battery manufacturing process. Activated MOF additive serves as an electrolyte modulator to enhance cationic transport and alleviates interfacial resistance by interacting liquid electrolyte with unsaturated open metal sites. Moreover, the flow-free liquid in solid configuration is realized by encapsulating liquid electrolyte into porous scaffold of MOF, which offers superior thermal stability.

### CROSS-REFERENCE TO RELATED PATENT APPLICATIONS

This application claims priority to and the benefit of, pursuant to 35 U.S.C. § 119(e), U.S. provisional patent application Ser. No. 62/803,725, filed Feb. 11, 2019.

This application is also a continuation-in-part application of U.S. patent application Ser. No. 15/888,223, filed Feb. 5, 2018, which claims priority to and the benefit of U.S. provisional patent application Ser. Nos. 62/455,752 and 62/455,800, both filed Feb. 7, 2017.

This application is also a continuation-in-part application of U.S. patent application Ser. No. 15/888,232, filed Feb. 5, 2018, which claims priority to and the benefit of U.S. provisional patent application Ser. Nos. 62/455,752 and 62/455,800, both filed Feb. 7, 2017.

This application is also a continuation-in-part application of U.S. patent application Ser. No. 16/369,031, filed Mar. 29, 2019, which itself claims priority to and the benefit of U.S. provisional patent application Ser. Nos. 62/650,580 and 62/650,623, both filed Mar. 30, 2018.

Each of the above-identified applications is incorporated herein by reference in its entirety.

### FIELD OF THE INVENTION

The present invention relates generally to batteries, and more particularly to electrodes having an electrode additive formed of metal-organic frameworks for high performance battery and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

The popularity of portable electronics and commercialization of electric vehicles stimulates the extensive research and substantial growth of battery market. Though current state of the art lithium ion batteries can achieve energy density of about 250 W h kg⁻¹, which corresponds to driving range of about 300 miles. The long charging time, formidable cost and safety concern from intrinsic flammability of liquid electrolyte significantly retard the widespread adoption of electric vehicle and green energy technology. Therefore, researchers tackle those issue from several scientific aspects. For instance, nanosized electrode materials can reduce the diffusion length and therefore the diffusion kinetics within the solid electrode is enhanced. Despite evident improvement in rate performance, this strategy compromises the tap density of electrode materials and it is relatively difficult for scaled up production. Moreover, the safety issue of liquid electrolyte can be alleviated by using ceramic or polymer based solid electrolyte, while the insufficient ionic conductivity and challenging interfacial resistance fall short of commercial applications. So far, seldom approach targeting industrial applications has been proposed to simultaneously resolve those key limitations existing in current batteries technologies. Therefore, a versatile yet readily applicable design in material or structure is of great significance in promoting the development for next-generation batteries and extensive utilization of renewable energy.

### SUMMARY OF THE INVENTION

One aspect of the invention provides a general type of porous coordination solids, metal-organic framework (MOF), as electrode additives to improve thermal stability, rate and cycle performances of batteries. The incorporation of MOF additives into electrodes is fully compatible with current battery manufacturing process. Activated MOF powders can serve as electrolyte modulator to enhance cationic transport and alleviate interfacial resistance by interacting liquid electrolyte with unsaturated open metal sites (OMS). Moreover, the flow-free liquid in solid configuration is realized by encapsulating liquid electrolyte into porous scaffold of MOF, which offers superior thermal stability.

Another aspect of the invention provides an electrode used for an electrochemical device. The electrode includes an electrochemical active material, a conductive additive, a binder and an electrode additive. The electrode additive comprises an MOF material defining a plurality of pores, where the MOF is a class of crystalline porous scaffolds constructed from metal cluster nodes and organic linkers. The MOF material is activated under vacuum at a temperature for a period of time.

In one embodiment, the MOF material comprises OMSs that are corresponding to unsaturated metal centers created by activating a pristine MOF material to remove guest molecules or partial ligands thereof.

In one embodiment, the MOF material is adapted such that a diameter of the pores provides a desired size to allow molecules of a liquid electrolyte to enter, and to accommodate salt anions in the liquid electrolyte.

In one embodiment, the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

In one embodiment, the MOF material comprises an zirconium-based MOF material with varied functional ligands comprising at least one of UiO-66 with the organic linkers of terephthalic acid; UiO-67 with the organic linkers of 4,4′-biphenyldicarboxylic acid; UiO-66-NH₂ with the organic linkers of 2-aminoterephthalic acid; UiO-66-NO₂ with the organic linkers of 2-nitroterephthalic acid; UiO-66-OH with the organic linkers of 2-hydroxyterephthalic acid; and UiO-66-Br with the organic linkers of 2-bromoterephthalic acid.

In one embodiment, the MOF material further has surface defects for exposing more unsaturated metal centers to coordinate salt anions in the liquid electrolyte.

In one embodiment, sites of the surface defects of the MOF material are tunable by changing at least one of a metal vs ligand ratio, a synthetic temperature and the organic linkers.

In one embodiment, the electrode additive, the electrochemical active material, the conductive additive and the binder are mixed at a weight ratio in one or more solvents to form a slurry that is evenly casted on a current collector substrate, and the electrode is formed after the one or more solvents is evaporated.

In one embodiment, the electrode additive comprises an activated UiO-66, the electrochemical active material comprises LiNi_{0.33}Co_{0.33}Mn_{0.33}O₂ (NCM), the conductive additive comprises acetylene black (CB), the binder comprises polyvinylidene fluoride (PVDF), and the one or more solvents comprise N-Methyl-2-pyrrolidone (NMP), wherein the weight ratio of the activated UiO-66, NCM, CB and PVDF is 1.7:91.7:3.3:3.3.

In one embodiment, the electrode additive comprises an activated UiO-66, the electrochemical active material comprises graphite or lithium titanate (Li₄Ti₅O₁₂, LTO), the conductive additive comprises CB, the binder comprises PVDF, and the one or more solvents comprise NMP, wherein the weight ratio of the activated UiO-66, graphite/LTO, CB and PVDF is 5:87:5:2.

Yet another aspect of the invention provides an electrochemical device comprising a positive electrode, a negative electrode, and a separator and an electrolyte disposed between the positive and negative electrodes. The electrolyte is a non-aqueous liquid electrolyte comprising a metal salt dissolved in a non-aqueous solvent. At least one of the positive and negative electrodes is the electrode as disclosed above, configured such that the activated MOF material is combined with and is soaked in the non-aqueous liquid electrolyte.

In one embodiment, the non-aqueous solvent is adapted such that its polarity matches surface properties of the MOF material.

In one embodiment, the non-aqueous solvent comprises one or more of ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, and cyclic ether compounds including at least one of tetrahydrofuran, 2-methyltetrahydrofuran, 1,3-dioxolane and dioxane.

In one embodiment, the metal salt is adapted to have anions with desired sizes to ensure that the metal salt infiltrates into at least some of the pores of the activated MOF material and then becomes immobilized therein to form ionic conducting channels. In one embodiment, the anions are bound to metal atoms of the MOF material and positioned within the pores of the MOF material.

In one embodiment, the metal salt comprises one or more of a lithium salt, a sodium salt, a magnesium salt, a zinc salt and an aluminum salt.

In one embodiment, the lithium salt comprises one or more of lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkyl sufonimides, lithium fluoroaryl sufonimides, lithium bis(oxalate borate), lithium tris(trifluoromethylsulfonylimide)methide, lithium tetrafluoroborate, lithium perchlorate, lithium tetrachloroaluminate, and lithium chloride.

In one embodiment, the sodium salt comprises one or more of sodium trifluoromethanesulfonate, NaClO₄, NaPF₆, NaBF₄, NaTFSI (sodium(I) Bis(trifluoromethanesulfonyl)imide), and NaFSI (sodium(I) Bis(fluorosulfonyl)imide).

In one embodiment, the magnesium salt comprises one or more of magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), and Mg(FSI)₂ (magnesium(II) Bis(fluorosulfonyl)imide).

In one embodiment, the zinc salt comprises one or more of zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide).

In one embodiment, the separator is either ionic conductive or non-conductive, and comprises one or more of poly-propylene (PP), poly-ethylene (PE), glass fiber (GF), polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, and copolymers of them, perovskite lithium lanthanum titanate Li₃ₓLa_{(2/3-x)}M_{(1/3)-2x}TiO₃ (LLTO) with 0<x<0.16 and M=Mg, Al, Mn or Ru, lithium phosphorous oxynitride (LiPON, Li_{3.5}PO₃N_{0.5}), garnet oxide including Li₅La₃M₂O₁₂ with M=Nb or Ta, or cubic LLZO: Li₇La₃Zr₂O₁₂, and lithium sulphide.

In one embodiment, the electrochemical device is a lithium battery. The positive electrode comprises one or more of LiCoO₂ (LCO), LiNiMnCoO₂ (NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide including LiNi_{0.5}Co_{0.15}Al_{0.05}O₂ or NCA, lithium vanadium oxide (LiV₂O₅), and Li₂MSiO₄ with M being composed of a ratio of Co, Fe, and/or Mn. The negative electrode may be formed of lithium metal (Li), graphite, hard or soft carbon, graphene, carbon nanotubes, titanium oxide (Li₄TisO₂, TiO₂), silicon (Si), tin (Sn), Germanium (Ge), silicon monoxide (SiO), silicon oxide (SiO₂), tin oxide (SnO₂), transition metal oxide (e.g., Fe₂O₃, Fe₃O₄, Co₃O₄, MnₓO_{y}, etc.), or any other suitable material that can undergo intercalation, conversion or alloying reactions with lithium.

In one embodiment, the electrochemical device is a sodium battery, a magnesium battery, or a zinc metal battery, where the positive electrode comprises one or more of NaMnO₂, NaFePO₄ and Na₃V₂(PO₄)₃ for the sodium battery, one or more of TiSe₂, MgFePO₄F, MgCo₂O₄ and V₂O₅ for the magnesium battery, or one or more of γ-MnO₂, ZnMn₂O₄, and ZnMnO₂ for the zinc battery.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1A show an illustrative configuration of electrode structure and components of a reference electrode.

FIG. 1B show an illustrative configuration of electrode structure and components according to embodiments of the invention.

FIG. 2A shows a topology structure of UiO-(66/67) serial MOFs, where the purple polyhedra 210 represent inorganic Zr₆O₄(OH)₄ clusters, the grey sticks 220 manifest organic linkers (BDC and BPDC for UiO-66 and UiO-67, respectively).

FIG. 2B shows schematic illustration for activation of UiO-(66/67) serial MOFs (purple: Zr, red: O, blue: H) according to embodiments of the invention. OMSs are created by dehydration of Zr₆O₄(OH)₄ units.

FIG. 2C shows N₂ adsorption/desorption measurement of UiO-66 according to embodiments of the invention.

FIG. 2D shows image of scanning electron microscopy showing the microstructure of synthesized UiO-66 according to embodiments of the invention.

FIG. 2E shows X-ray powder diffraction pattern of synthesized and activated UiO-66 according to embodiments of the invention.

FIG. 3A shows the cyclic voltammetry of an NCM cathode (LiNi_{0.33}Co_{0.33}Mn_{0.33}O₂, a reference electrode, denoted as REF), where metallic Li was used as both reference and counter electrodes.

FIG. 3B shows the cyclic voltammetry of an NCM cathode with MOF additive (a high-performance electrode, abbreviated as HPE) at a variety of sweep rate according to embodiments of the invention, where metallic Li was used as both reference and counter electrodes.

FIG. 3C compares the Li diffusion coefficient of the REF and HPE based on Randles-Selick equations according to embodiments of the invention.

FIG. 4 shows the long-term cycling performance comparison between the REF and HPE using NCM-NCM symmetric cell configurations according to embodiments of the invention.

FIGS. 5A-5D show the evolution comparison of electrochemical impedance spectroscopy (EIS) between the REF and HPE according to embodiments of the invention.

FIG. 6A shows the cycling performance comparison between the REF and HPE using graphite-graphite (C—C) symmetric cell configurations according to embodiments of the invention.

FIG. 6B shows the cycling performance comparison between the REF and HPE using Li₄Ti₅O₁₂—Li₄Ti₅O₁₂ symmetric cell configurations according to embodiments of the invention.

FIGS. 7A-7C show the cycling performance comparisons between the REF and HPE using NCM-C full cell configurations at different rates according to embodiments of the invention.

FIG. 8 shows the cycling performance comparisons between the REF and HPE using NCM-C pouch cell according to embodiments of the invention.

### DETAILED DESCRIPTIONS OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation showed in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used in this invention, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

One aspect of the invention discloses a general type of porous coordination solids, metal-organic framework (MOF), as electrode additives to improve thermal stability, rate and cycle performances of batteries and an electrode having the electrode additive. The incorporation of MOF additives into electrodes is fully compatible with current battery manufacturing process. In certain embodiments, activated MOF powders serve as electrolyte modulator to enhance cationic transport and alleviate interfacial resistance by interacting liquid electrolyte with unsaturated open metal sites (OMS). Moreover, the flow-free liquid in solid configurations is realized by encapsulating liquid electrolyte into porous scaffold of MOF, which offers superior thermal stability.

Another aspect of the invention provides an electrode used for an electrochemical device. The electrode includes an electrochemical active material, a conductive additive, a binder and an electrode additive. The electrode additive comprises an MOF material defining a plurality of pores, where the MOF is a class of crystalline porous scaffolds constructed from metal cluster nodes and organic linkers. The MOF material is activated under vacuum at a temperature for a period of time.

In one embodiment, the MOF material comprises OMSs that are corresponding to unsaturated metal centers created by activating a pristine MOF material to remove guest molecules or partial ligands thereof.

In one embodiment, the MOF material is adapted such that a diameter of the pores provides a desired size to allow molecules of a liquid electrolyte to enter, and to accommodate salt anions in the liquid electrolyte.

In one embodiment, the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

In one embodiment, the MOF material comprises an zirconium-based MOF material with varied functional ligands comprising at least one of UiO-66 with the organic linkers of terephthalic acid; UiO-67 with the organic linkers of 4,4′-biphenyldicarboxylic acid; UiO-66-NH₂ with the organic linkers of 2-aminoterephthalic acid; UiO-66-NO₂ with the organic linkers of 2-nitroterephthalic acid; UiO-66-OH with the organic linkers of 2-hydroxyterephthalic acid; and UiO-66-Br with the organic linkers of 2-bromoterephthalic acid.

In one embodiment, the MOF material further has surface defects for exposing more unsaturated metal centers to coordinate salt anions in the liquid electrolyte.

In one embodiment, sites of the surface defects of the MOF material are tunable by changing at least one of a metal vs ligand ratio, a synthetic temperature and the organic linkers.

In one embodiment, the electrode additive, the electrochemical active material, the conductive additive and the binder are mixed at a weight ratio in one or more solvents to form a slurry that is evenly casted on a current collector substrate, and the electrode is formed after the one or more solvents is evaporated.

In one embodiment, the electrode additive comprises an activated UiO-66, the electrochemical active material comprises LiNi_{0.33}Co_{0.33}Mn_{0.33}O₂(NCM), the conductive additive comprises acetylene black (CB), the binder comprises polyvinylidene fluoride (PVDF), and the one or more solvents comprise N-Methyl-2-pyrrolidone (NMP), wherein the weight ratio of the activated UiO-66, NCM, CB and PVDF is 1.7:91.7:3.3:3.3.

In one embodiment, the electrode additive comprises an activated UiO-66, the electrochemical active material comprises graphite or lithium titanate (Li₄Ti₅O₁₂, LTO), the conductive additive comprises CB, the binder comprises PVDF, and the one or more solvents comprise NMP, wherein the weight ratio of the activated UiO-66, graphite/LTO, CB and PVDF is 5:87:5:2.

In one aspect, the invention also provides an electrochemical device such as a battery comprising a cathode and an anode (i.e., two electrodes) as redox couples, and a separator and an electrolyte as an ionic conductor disposed between the two redox electrodes.

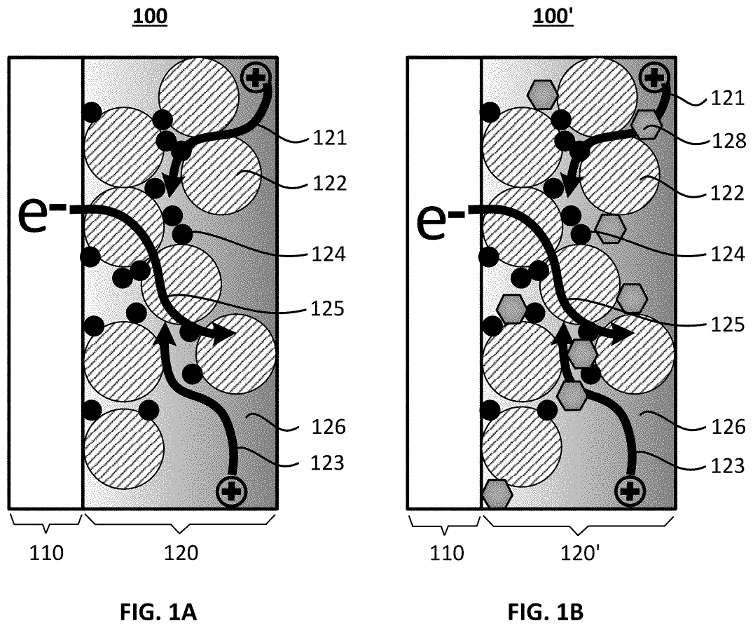

FIGS. 1A and 1B show respectively two illustrative schemes for electrode configurations (alternatively, a cathode or an anode) 100 and 100′, each of which includes a current collector 110 and a composite electrode 120/120′ (in electrolyte 126) attached to the current collector 110. The composite electrode 120/120′ is in electrolyte 126 and includes an electrochemical active material 122, a conductive additive 124 and a binder (not shown). The adherence of the electrode 120/120′ on the current collector 110 is to ensure the continuous electron flow to outside circuit.

For a typical procedure of preparing electrodes, the electrochemical active material, the conductive additive and the binder are mixed and dispensed in appropriate solvents. The resulting homogenous electrode slurry 120/120′ are evenly casted on a planar current collector substrate 110. The solvents are evaporated by drying to create porous electrodes 120/120′. The porous electrodes 120/120′ prepared from the slurry casted method guarantees the ionic transport 121, 123 and 125 by imbibing liquid electrolyte 126 into the porous voids.

In the exemplary examples disclosed herein, the MOF additives 128 are added either into a cathode or an anode as an additional electrode component with no extra cost, as shown in FIG. 1B. After assembling the dry cells and injecting liquid electrolyte 126, the MOFs 128 within the electrode 120′ can spontaneously imbibe the liquid electrolyte 126 upon cell aging. The resulting MOFs simultaneously serve as an electrolyte reservoir to withhold the liquid electrolyte 126 and act as a modulator to and tune ionic chemistry. On one hand, the safety issue is mitigated by confining the liquid electrolyte in porous solids; on the other hand, the OMS in the MOF promotes the cation transport by relatively immobilize the anions.

The role of the electrolyte modulator may be realized by spontaneously binding electrolyte anions, e.g., ClO₄⁻, BF₄⁻, PF₆⁻, TFSI (bis(trifluoromethane)sulfonimide), FSI (bis(fluorosulfonyl)imide), etc., to the open-metal sites of the MOF scaffolds. The binding constructs negatively charged channels in the pores of the MOF scaffold, which enable fast conduction of solvated ions, e.g., Li⁺, Na⁺, K⁺, Mg²⁺, Zn²⁺, Al³⁺, etc.

In certain embodiments, for lithium-based batteries, the positive electrode may be formed of LiCoO₂ (LCO) and the negative electrode may be formed of lithium metal (Li). Other examples of suitable positive electrodes include, but are not limited to, LiNiMnCoO₂ (NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide (e.g., LiNi_{0.5}Co_{0.15}Al_{0.05}O₂ or NCA, etc.), lithium vanadium oxide (LiV₂O₅), Li₂MSiO₄ (M is composed of any ratio of Co, Fe, and/or Mn), or any other suitable material that can sufficiently undergo lithium insertion and deinsertion. Other examples of suitable negative electrodes include, but are not limited to, graphite, hard or soft carbon, graphene, carbon nanotubes, titanium oxide (Li₄Ti₅O₁₂, TiO₂), silicon (Si), tin (Sn), Germanium (Ge), silicon monoxide (SiO), silicon oxide (SiO₂), tin oxide (SnO₂), transition metal oxide (e.g., Fe₂O₃, Fe₃O₄, Co₃O₄, MnₓO_{y}, etc.), or any other suitable material that can undergo intercalation, conversion or alloying reactions with lithium.

In certain embodiments, other electrodes may be used for sodium, magnesium, or zinc metal batteries. For example, suitable negative electrodes for sodium, magnesium, or zinc metal batteries include, but are not limited to, sodium metal, magnesium metal, or zinc metal, respectively. Suitable positive electrodes for sodium metal batteries include, but are not limited to, NaMnO₂, NaFePO₄, and Na₃V₂(PO₄)₃; suitable positive electrodes for magnesium metal batteries include, but are not limited to, TiSe₂, MgFePO₄F, MgCo₂O₄, and V₂O₅; and suitable positive electrodes for zinc metal batteries include, but are not limited to, γ-MnO₂, ZnMn₂O₄, and ZnMnO₂.

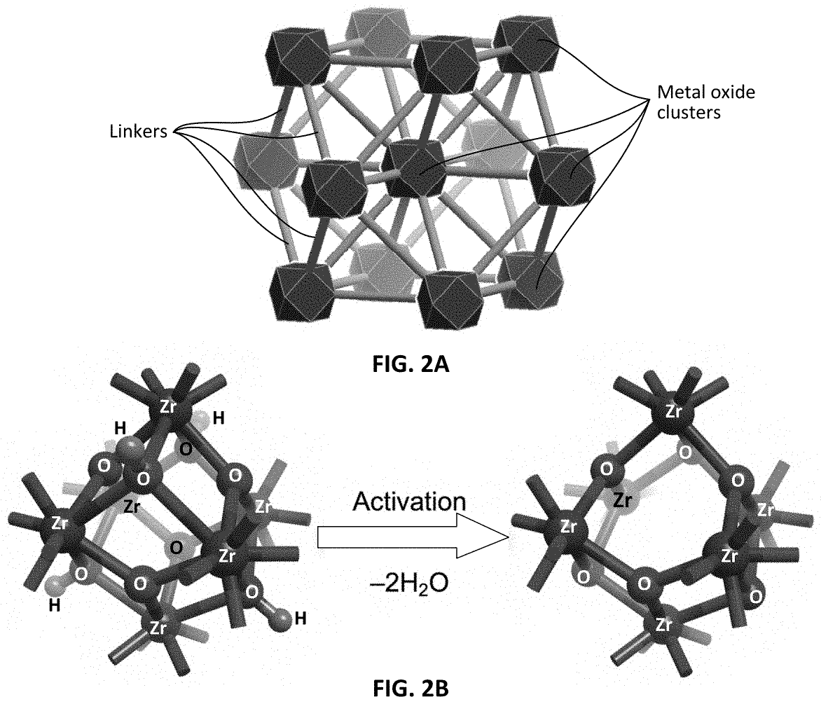

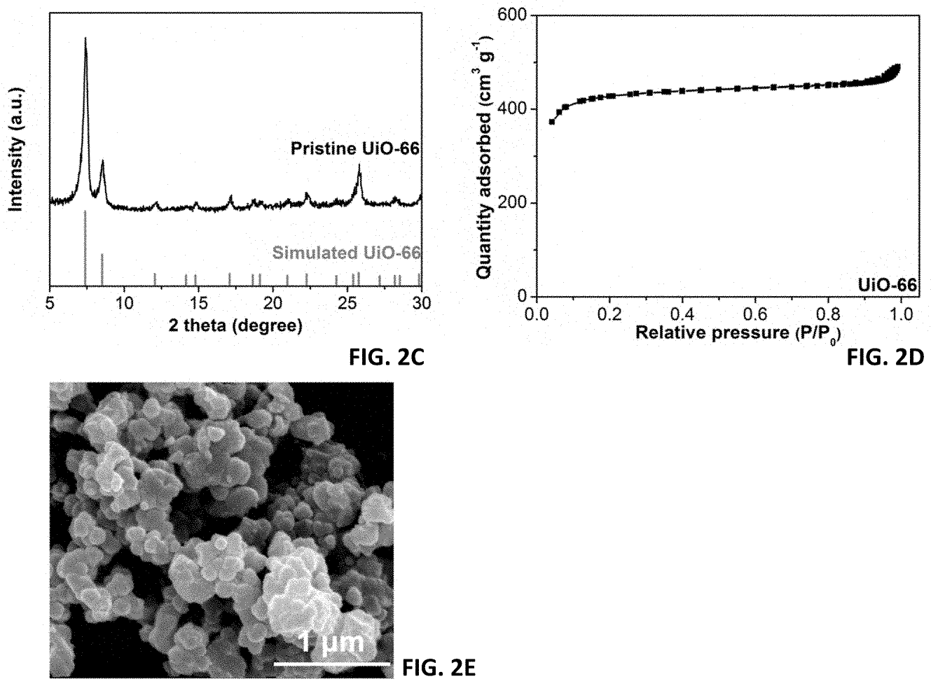

MOFs are a class of crystalline materials constructed from metal centers and organic ligands, which have ordered nano-pores or nano-channels that are capable of hosting guest species. As described in detail below, the pores of the MOF are large enough to accommodate the metal salt. More particularly, the pores of the MOF are large enough to accommodate the binding of anions of a metal salt to the open metal backbone of the MOF, as well as solvated cations of the metal salt, such as, lithium ions and sodium ions. An exemplary example of the MOFs, such as MIL-100(Al), is shown in FIG. 2A. More specifically, MIL-100 serial MOFs (M₃O(BTC)₂OH(H₂O)₂) are built from M³⁺(M=Al, Cr, Fe) octahedra trimer sharing a common μ₃-O. Each M³⁺ is bonded to four oxygen atoms of bidendate dicarboxylate (BTC), and their linkage generates a hierarchical structure with mesoporous cages (25 and 29 Å) that are accessible through microporous windows (6 and 9 Å). The corresponding terminals in octahedra are generally occupied by removable guest molecules.

Table 1 lists some exemplary MOF candidates that may be used as the channel scaffolds with pore size ranging from 1.1 nm to 2.9 nm, containing metal centers from the p-block (Al and In) and from the d-block (Cu, Fe, and Mn), as well as different ligands, e.g., benzene-1,3,5-tricarboxylic acid (BTC), benzene-1,4-dicarboxylic acid (BDC), and biphenyl-4,4′-dicarboxylic acid (BPDC).

TABLE 1
Selected MOFs for high-performance electrode additives

| | Formula | Ligand Structure | Pore size (nm) |
|---|---|---|---|
| HKUST-1 | Cu₃(BTC)₂ | BTC | 1.1 |
| MIL-100-Al MIL-100-Cr MIL-100-Fe | Al₃O(OH)(BTC)₂ Cr₃O(OH)(BTC)₂ Fe₃O(OH)(BTC)₂ | 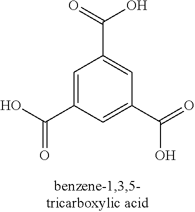 | 2.5, 2.9 (windows: 0.6, 0.9) |
| UiO-66 | Zr₆O₄(OH)₄(BDC)₆ | 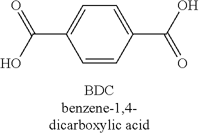 | 0.75, 1.2 |
| UiO-67 | Zr₆O₄(OH)₄(BPDC)₆ | 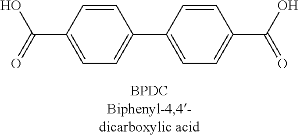 | 1.2, 2.3 |

It should be appreciated that other MOF materials may also be selected, based on having suitable pore size, pore volume, metal centers, and good compatibility to the liquid electrolyte that is used to form the ionic channels. Since the liquid electrolyte to be infiltrated into the MOFs, MOF structures can be selected and modified easily, and different MOF structures can be designed to meet certain requirements of different rechargeable batteries by changing and modifying the liquid electrolyte. In one example, the MOF structure may be initially selected such that a diameter of the pores provides a large enough size to allow molecules of the liquid electrolyte to enter, and to accommodate the anions of the salt in the liquid electrolyte.

Further, the MOF material selection may also be based on the stability of the MOFs in the battery electrochemical environment. The judicious selection of the metal centers and organic linkers (ligands) affords the synthesis of over 20,000 MOFs with designable functionalities and pore channels. As examples, MOFs with mesopore structures may be synthesized by using a large ligand. One example of the MOFs with a mesopore structure is the UiO-67. MOFs with more surface functional groups for coordinating liquid electrolytes may also be used. Other examples of suitable MOF materials include, but are not limited to, Mil-100 serial MOFs, where pore topology is small while metal center varies. It should be appreciated that any MOF may be used in the examples disclosed herein and to practice the invention.

Table 2 lists another serial examples of MOFs. UiO-66 stands for Zirconium MOF with perfect stoichiometry of [Zr₆O₄OH₄][C₆H₄(COO)₂]₆. The synthetic route is hydrothermal reactions between ZrCl₄ with terephthalic acid (BDC) in a polar (hydrophilic) aprotic solvent of dimethylformamide (DMF). Zr⁴⁺ is gradually hydrolyzed to form a six-center octahedral metal cluster with the assistance from basicity of DMF. Capping the faces of metal cluster octahedron are eight oxygen, of which four a protonated to balance the charge. The cationic Zr₆O₄OH₄ microporous cages of 7.5 to 12 Å. Another isostructural material UiO-67 can be obtained by replacing the terephthalic acid (BDC) with longer linker of 4,4′-biphenyldicarboxylic acid (BPDC). The consequent pore size expands from 7.5 and 12 Å to 12 and 16 Å, respectively. Both UiO-66 and UiO-67 share almost identical Zirconium metal octahedron, it undergoes a dehydration by removal of two water molecules from the cages, thus creating partially open metal sites as well as local polarized framework surface.

In certain embodiments, several derivatives of these MOFs are synthesized with linker possessing functional groups such as amines, halogens, hydroxyls or nitros, as enclosed in Table 2. The vast diversity of functional side groups introduces desirable properties for the MOFs as solid electrolyte, like higher ionic conductivity, higher transference number and superior stability against reactive alkali metals. For instance, electron donor/acceptor properties of side groups would impact the acidity of benzene carboxylate, thus shifting the charge balance of overall metal organic framework and resulting anion adsorption capability. In addition, self-sacrificial decomposition of nitrogen or halogen containing groups from MOF ligand in contact with lithium would generate solid-state interface (SEI) comprising lithium nitrate or lithium halogen, which are well known to be good lithium conductor and protector of lithium from continuous consumptive reaction with liquid electrolyte.

TABLE 2
Zirconium-based MOF with varied functional ligands

| Zirconium-based | | |
|---|---|---|
| MOF | Ligand Structure | |
| UiO-66 | Terephthalic acid (BDC) | 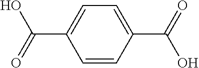 [SMILES: O=C(O)c1ccc(C(=O)O)cc1] |
| UiO-67 | 4,4′-biphenyldicarboxylic acid (BPDC) | 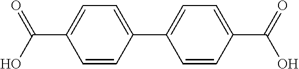 [SMILES: O=C(O)c1ccc(-c2ccc(C(=O)O)cc2)cc1] |
| UiO-66-NH₂ | 2-Aminoterephthalic acid (NH₂-BDC) | 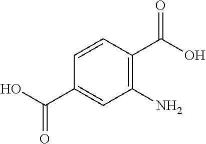 [SMILES: Nc1cc(C(=O)O)ccc1C(=O)O] |
| UiO-66-NO₂ | 2-nitroterephthalic acid (NO₂-BDC) | 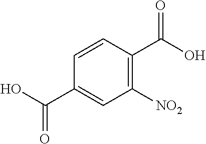 [SMILES: O=C(O)c1ccc(C(=O)O)c([N+](=O)[O-])c1] |
| UiO-66-OH | 2-Hydroxyterephthalic acid (OH-BDC) | 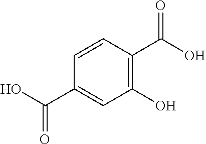 [SMILES: O=C(O)c1ccc(C(=O)O)c(O)c1] |
| UiO-66-Br | 2-Bromoterephthalic acid (Br-BDC) | 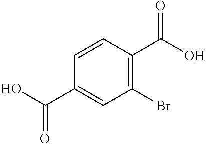 [SMILES: O=C(O)c1ccc(C(=O)O)c(Br)c1] |

Before adding MOFs into aforementioned electrode materials, the synthesized MOFs undergo a pre-treatment step: activation. Generally, the MOFs are synthesized in the presence of a solvent (e.g., water) and the ligands, both of which coordinate with the MOF's metal centers. Removal of the solvent molecules (or dehydration of capping hydroxyl groups, e.g., as shown in FIG. 2B) at an elevated temperature under vacuum breaks the solvent coordination from the MOFs, resulting in MOF scaffolds with unsaturated metal centers. Specifically, for a UiO serial MOF, the activation process is illustrated in FIG. 2B, UiO-66 is obtained by bridging Zr₆O₄(OH)₄ inorganic clusters with BDC linkers (BDC=1,4-dicarboxylate). The Zr₆-octahedrons are alternatively coordinated by μ₃-O, μ₃-OH and O atoms from BDC, where μ₃-OH can undergo dehydration to form a distorted Zr₆O₆ node (seven-coordinated Zr) upon thermal activation. Upon activation, the Zr₆O₄(OH)₄ units (eight-coordinated Zr) undergo dehydration and the resulting Zr₆O₆ clusters (seven-coordinated Zr) possess unsaturated open Zr⁴⁺ sites. The conditions of thermal activation for coordinating molecule removal vary by different MOFs, which depend on the synthetic conditions and thermal stability of MOFs. In one example, the powder form an MOF material may be degassed or activated under vacuum at a high/elevated temperature (e.g., about 350° C.) to remove coordinated water molecules. In addition to the thermal activation for creating open metal sites, other methods for removing coordinating molecule including supercritical drying, solvent exchange, lyophilization, etc., may also be used to practice the invention.

During synthesis of the MOFs, surface defects may be created. The surface defects of the MOF materials are similar to pores in that they expose more unsaturated metal centers to coordinate salt anions. Therefore, the pores inside of the MOF materials, as well as the defects resulting from the packing of the MOF materials, can become ion transportation channels. As for UiO-66 series MOFs, metal vs ligand ratio, synthetic temperature, hydrochloric acid as well as incorporation of mono/di-carboxylic acid are manipulated to tune the MOF defects sites. For instance, trifluoroacetic acid, trichloroactic acid, formic acid, acetic acid, pivalic acid, benzoic acid, and stearic acid, etc., are effective in creating massive missing ligands by replacement of terephthalic acid and decomposition upon activation, thus resulting MOFs possess defective structure and abundant sites for coordinating anions. In the MOFs disclosed herein, these defects throughout the frameworks are also classified as immobilization sites for anion and transport facilitator for cations.

The activated MOF material powder is combined with, and is soaked in, a non-aqueous liquid electrolyte including metal salt(s) dissolved in non-aqueous solvent(s). The non-aqueous liquid electrolyte solvent(s) include, but are not limited to, ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including gamma butyrolactone, gamma valerolactone, 1,2-dimethoxyethane and diethyl ether, cyclic ether compounds including tetrahydrofuran, 2-methyltetrahydrofuran, 1,3-dioxolane and dioxane, or mixtures of two or more of these solvents. In certain embodiments, the polarity of the non-aqueous solvent(s) may be selected to match the surface properties of the MOF material.

The metal salt dissolved in the liquid electrolyte solvent includes, but are not limited to, a lithium salt, a sodium salt, a magnesium salt, a zinc salt and/or an aluminum salt.

Examples of suitable lithium salts include, but are not limited to, lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, and combinations thereof.

Examples of suitable sodium salts include sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), and the like.

Examples of suitable magnesium salts include, but are not limited to, magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), and the like.

Examples of suitable Zn salts include, but are not limited to, zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), and the like.

In certain embodiments, the metal salt is selected to have a suitably sized anion, which depends, at least in part, upon the MOF material that is used. The anion size may be selected to ensure that the salt can infiltrate into at least some of the MOF pores, and then become immobilized therein to form the ionic conducting channel.

The weight percentage of activated MOFs varies by different applications. The electrode preparation is exemplified but not restricted by traditional slurry casted method, for example, aerosol sprayed electrodes, ink printed electrodes, calendared electrodes, electrospun electrodes and electroplated electrodes, etc., are also applicable. The uniformity of combined electrode components including active materials, conductive additives, binders and MOFs can be achieved by mixing dry powders or wet mixing using dispersing solvent. The approach of combining MOF with other electrode components is exemplified but not restricted by physical mixing. Due to versatile functional groups existing in MOFs, it is also applicable to form composite materials between the MOFs and other electrode components including active materials, electrodes, conductive additives and binder.

The MOFs incorporated electrodes possess intrinsic porosity from MOFs and interparticle porosity, therefore injected electrolyte can readily be infiltrated into the porous structure. Soaking activated MOFs in liquid electrolyte (e.g., LiClO₄ in propylene carbonate (PC)) allows the anions (e.g., ClO₄⁻) of the metal salt to bind to the unsaturated metal sites of the MOFs and spontaneously form anion-bound MOF channels. In other words, the anions are bound to metal atoms of the MOFs such that the anions are positioned within the pores of the MOFs. After formation, the negatively charged MOF channels are ion transport channels that allow for effective transport of the solvated cations (e.g., PC-solvated Li⁺ or Na⁺ or Zn²⁺ or Mg²⁺). The solvated cations may hop through and/or between the plurality of negatively charged MOF channels. More particularly, the solvated cations can transfer within and/or between the channels by hopping among each of the anions and/or solvents. In the pores, composed by the MOF units, the cations transfer with the help of the solvent.

In certain embodiments, the electron blocking separator membranes between two redox electrodes can either be ionic conductive (any gel forming polymer electrolyte or solid electrolyte) or non-conductive, which can be selected from poly-propylene (PP), poly-ethylene (PE), glass fiber (GF), polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, copolymers thereof, perovskite lithium lanthanum titanate Li₃ₓLa_{(2/3-x)}M_{(1/3)-2x}TiO₃ (LLTO, 0<x<0.16, M=Mg, Al, Mn, Ru, etc.), lithium phosphorous oxynitride (LiPON, Li_{3.5}PO₃N_{0.5}), garnet oxide (Li₅La₃M₂O₁₂, M=Nb, Ta, cubic LLZO: Li₇La₃Zr₂O₁₂), lithium sulphide and/or combinations thereof.

According to the invention, the foregoing MOF porous solids serve as an electrolyte modulator, transforming ionic chemistry of electrolyte by immobilizing anion and facilitating cation transport. The polarization induced by anion movements is reduced and resulting modified electrolyte is projected to benefit from following advantages. (1) As for rechargeable lithium batteries, the restricted movements of anion give rise to enhanced cation transference number, thereby improving power capability. (2) Parasitic reactions involving anion are mitigated, thereby prolonging the cycle life. The MOF electrolyte modulator can also be applied to lithium metal batteries. (3) Incorporation of solid MOFs helps with mechanical and thermal stability; (4) Alleviated interfacial resistance either from self-healing decomposition of ligands or from tunable surface area/particle size of MOFs assists in eliminating metallic dendrites.

These and other aspects of the present invention are further described in the following section. Without intending to limit the scope of the invention, further exemplary implementations of the present invention according to the embodiments of the present invention are given below. Note that titles or subtitles may be used in the examples for the convenience of a reader, which in no way should limit the scope of the invention. Moreover, certain theories are proposed and disclosed herein; however, in no way should they, whether they are right or wrong, limit the scope of the invention so long as the invention is practiced according to the invention without regard for any particular theory or scheme of action.

### Example 1

In this exemplary example, the synthesis of UiO-66 MOF includes the following steps. About 1.23 g of BDC ligand and about 1.25 g of ZrCl₄ were dissolved in 100 mL of N,N-dimethylformamide (DMF) and about 50/10 mL of DMF/hydrochloric acid (37 wt % HCl, concentrated) mixture, respectively. These two fully dissolved solutions were combined and magnetically stirred for an additional about 30 min. The resulting transparent precursor solution was loaded in a tightly sealed glass vial and heated at about 150° C. for about 20 hours. Afterwards, the precipitate was separated from solvents by centrifugation and first washed by DMF three times (3×40 mL). Methanol exchange was performed on the DMF-washed sample over a period of about 3 days. The sample was replenished with fresh methanol twice a day (each for about 40 mL). Eventually the sample was dried at about 80° C. for about 1 day prior to further characterization.

As showed in FIG. 2C, the crystal structure was determined by X-ray diffraction pattern, all peaks were indexable to simulated patterns for UiO-66 and no impurities were detected. The texture property of porous MOF solids was evaluated by N₂ adsorption/desorption isotherms. Before surface area measurements, the porous powders undergo a heat treatment at about 180° C. for about 12 hours under a pressure of about 20 um Hg. As shown in FIG. 2D, the Brunauer-Emmett-Teller (BET) surface area is calculated to be about 1375 cm² g⁻¹ and the majority pores are micropores as indicated by dominate adsorption at a low relative pressure. The morphology and particle size were examined by scanning electron spectroscopy (SEM), as shown in FIG. 2E, the products include microsized aggregates of intergrown crystals. It is worthy to note that, the crystallinity, particle size, surface area and defects of the MOF can further be readily tuned by a variety of synthetic strategies, like using more water or other acid modulator, hydrochloric acid, acetic acid, trifluoroacetic acid, stearic acid, etc.

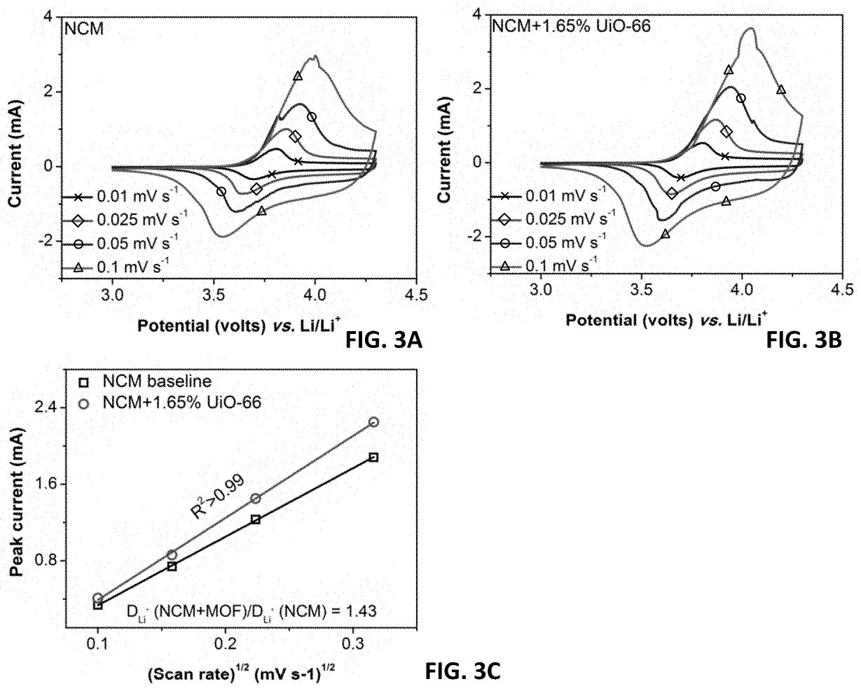

The MOF additive used herein is exemplified while not restricted to UiO-66. The synthesized UiO-66 underwent a heat treatment (about 350° C.) under vacuum for thermal activation purposes. The activated UiO-66 were homogeneously mixed with LiNi_{0.33}Co_{0.33}Mn_{0.33}O₂ (NCM), acetylene black (CB), polyvinylidene fluoride (PVDF) by a weight ratio of 1.7:91.7:3.3:3.3 in N-Methyl-2-pyrrolidone (NMP), afterwards the resulting electrode slurry were coated on an aluminum current collector using a doctor blade. The ratio between electrode components is for the demonstration purpose and optimized ratio is subject to engineering process. After two step drying at about 80° C. and about 170° C. under vacuum. The baked electrodes were calendered to thickness of about 60 um with NCM loading of about 15 mg cm⁻². For the reference electrodes without MOF, the NCM content is about 93.3% instead while maintaining contents of CB and PVDF the same. Finally, the prepared electrodes were tailored into electrode disks with a diameter of about 14 cm for use. For CR-2032 type coin cells, metallic lithium disks (15.6 cm diameter, MTI) were used as both counter and reference electrodes, liquid electrolyte 1M LiPF₆ in EC/DEC (ethylene carbonate/diethylene carbonate, w:w=1:1, BASF®) is commercially available, and the 25 um trilayer polypropylene-polyethylene-polypropylene membrane is purchased from Celgard®. FIGS. 3A-3B show respectively the cyclic voltammetry of an NCM cathode (LiNi_{0.33}Co_{0.33}Mn_{0.33}O₂, REF) and an NCM cathode with the MOF additive (HPE) at a variety of sweep rate, where metallic Li was used as both the reference and counter electrodes.

To distinguish the role of MOF additives within the electrodes, the diffusion coefficient of Li⁺ within the electrodes were characterized by cyclic voltammetry technique. As known from Randles-Selick equation: Iₚ∝C_{Li}_{⁺}·(v)^{1/2}(D_{Li}_{⁺})^{1/2}, where Iₚ is a peak redox current, C_{Li}_{⁺} is a concentration, v is a sweep rate, D_{Li}_{⁺} is a diffusion coefficient. The NCM-Li half cells both without (a reference electrode, REF) and with MOF additives (a high-performance electrode, HPE) were assembled, and stepped CV sweeps at a varied rate (from about 0.01 to about 0.1 mV s⁻¹) were performed. The resulting curves were linearly fitted into plots with (v)^{1/2} as x axis and Iₚ as y axis. By comparing the slopes of two plots shown in FIG. 3C, it is tentatively concluded that the Li diffusion coefficient of the HPE was enhanced by 43% by incorporating MOF as electrode additives.

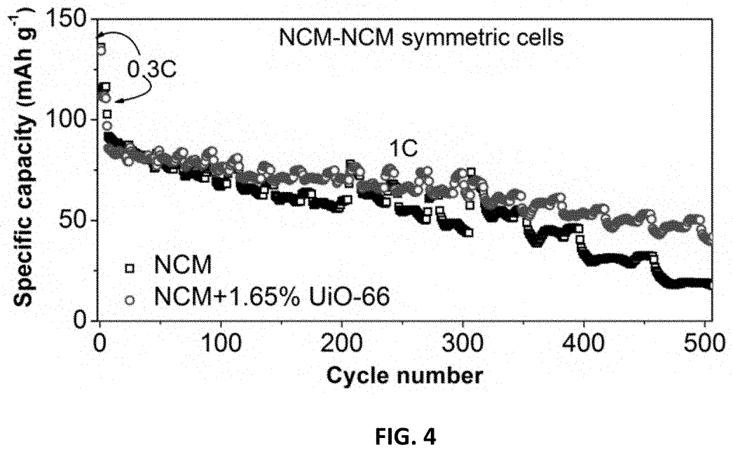

The long-term cycling performance of NCM electrodes were evaluated by a symmetric cell configuration to eliminate the impact of interface between Li with electrolyte. Firstly, partial xLi in Li₁₋ₓNi_{0.33}Co_{0.33}Mn_{0.33}O₂ was extracted by charging NCM-Li half-cells to about 4.3V at about 0.1 C (1 C=16 mA g^{-l}), thereafter the charged NCM electrodes were harvested and paired with fresh NCM electrodes. As for NCM with MOF additives, about 1.65% UiO-66 was added into electrodes, which are denoted as high-performance electrodes (HPE). The fabricated NCM-NCM symmetric cells were subject to galvanostatic cycling under about 0.3 C for about 5 cycles and 1 C rate afterwards. The REF (NCM) exhibits about 0.17% capacity fading per cycle, which is much higher than the HPE (about 0.1%) over about 500 cycles. Besides, the average Coulmobic efficiency of the HPE is improved from about 99.88% for REF to about 99.94%. The superior cycling performance demonstrates that MOF additive is able to alleviate the parasitic reactions between positive electrodes and electrolyte. The long-term cycling performance comparison between REF and HPE using NCM-NCM symmetric cell configurations is shown in FIG. 4.

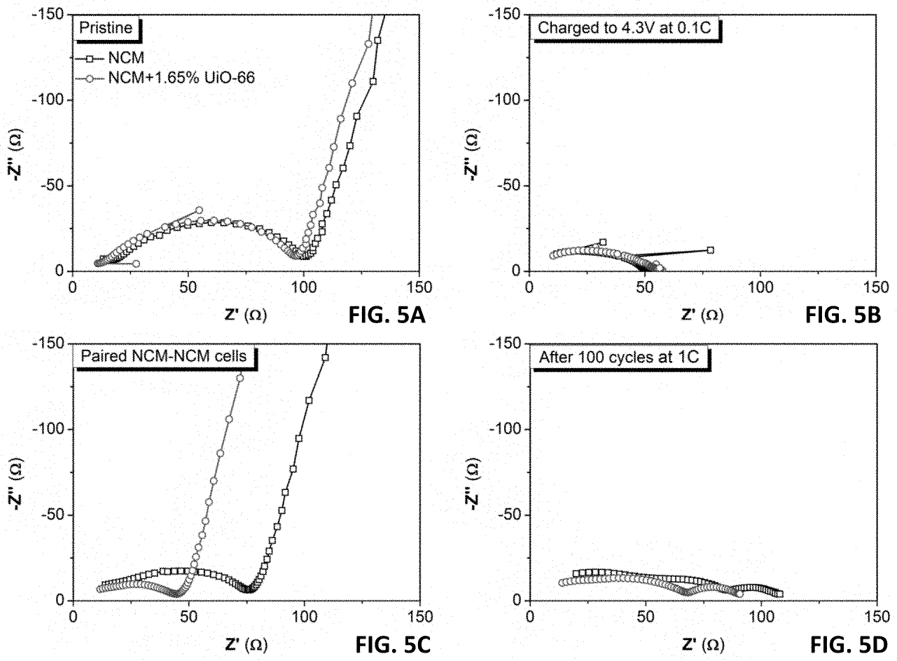

To reveal the mechanism behind the improvements, a series of electrochemical impedance spectroscopy tests were performed. Firstly, the Nyquist plots of fresh NCM-Li half-cells show a semicircle accompanied with a sloping line, which can be ascribed to the interfacial resistances (NCMILi with electrolyte, denoted as Rct) and diffusion process, respectively. After charging the NCM to about 4.3V at about 0.1 C, almost identical depressed semicircles for both the REF and HPE are observed. However, the paired NCM-NCM symmetric cells exhibit dramatic distinction in terms of Rct, where HPE shows about 50% reduction of Rct compared with REF. The difference is maintained even after about 100 cycles at about 1 C. The comparisons of impedance evolution illustrate that MOF within the electrodes is able to alleviate the interfacial resistance, which is of importance especially for low-temperature application and high rate operation. The evolution comparisons of electrochemical impedance spectroscopy (EIS) between the REF and HPE is shown in FIGS. 5A-5D.

### Example 2

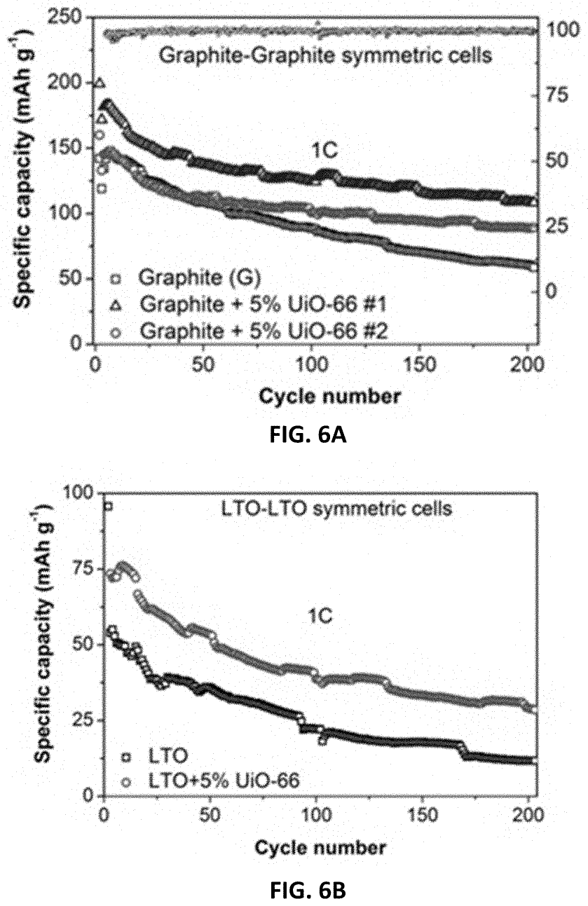

Besides the NCM cathode, performances of typical anodes including graphite (C) and lithium titanate (Li₄Ti₅O₁₂, LTO) with MOF additives were also explored. The MOF additive used here is exemplified while not restricted to UiO-66. The activated UiO-66 were homogeneously mixed with graphite/LTO, acetylene black (CB), polyvinylidene fluoride (PVDF) by a weight ratio of 5:87:5:2 in N-Methyl-2-pyrrolidone (NMP), afterwards the resulting electrode slurry were coated on copper current collect using a doctor blade. The ratio between electrode components is for demonstration purpose and optimized ratio is subject to engineering process. After two step drying at 80 and 170° C. under vacuum. The baked electrodes were calendered to thickness of 60 um with anode loading of 7.5 mg cm⁻². For the reference electrodes without MOF, the graphite/LTO content is 92% instead while maintaining contents of CB and PVDF the same. Finally, the prepared electrodes were tailored into electrode disks with diameter of 14 cm for future use. The performance improvements are summarized in Table 3 (1 C for graphite is 374 mA g⁻¹, 1 C for LTO is 170 mA g^{-l}). The cycling performance comparison between the REF and HPE using a graphite-graphite (C—C) symmetric cell configuration and an Li₄Ti₅O₁₂—Li₄Ti₅O₁₂ symmetric cell configuration, are shown in FIGS. 6A and 6B, respectively.

TABLE 3
Performance improvements of electrodes using MOF additives

| | | Graphite | LTO | NCM |
|---|---|---|---|---|
| Added UiO-66 wt % | | 5 | 5 | 1.65 |
| Fading per cycle | REF | 0.3% | 0.4% | 0.17% |
| | HPE | 0.2% | 0.3% | 0.1% |
| CE (200 cycles) | REF | 99.46% | 99.50% | 99.91% |
| | HPE | 99.84% | 99.80% | 99.95% |

| | | | |
|---|---|---|---|
| D_{Li+} enhancement | +93% | +75% | +43% |

### Example 3

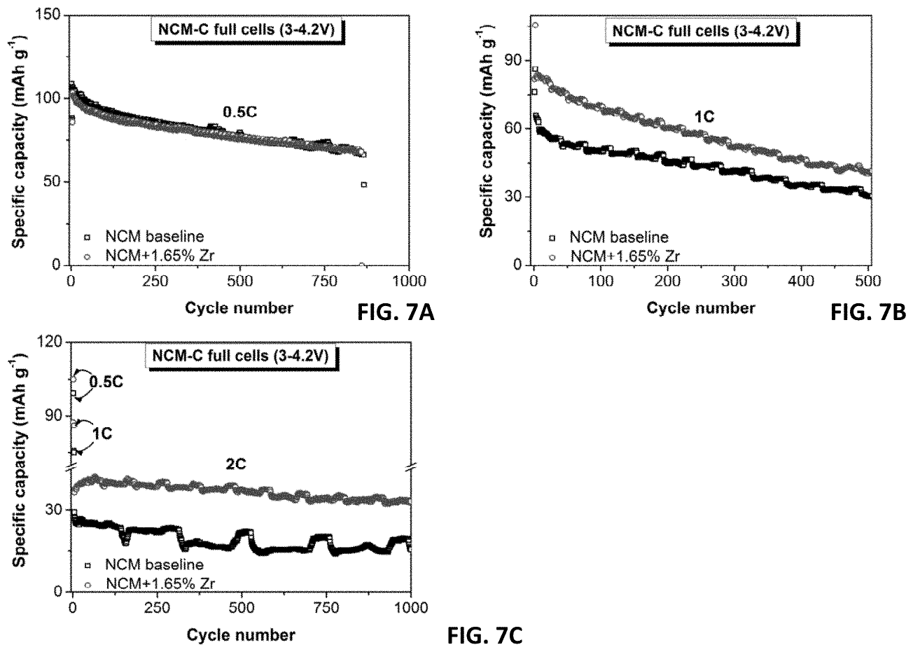

To illustrate the superiority of MOF additives in a full cell configuration, NCM-C full cell (weight ratio between NCM and graphite is 15:7.5 mg cm⁻²) in coin cells were fabricated, where MOF additives were added to the cathode side. The combination of NCM and graphite is for demonstrative purposes and any combination of aforementioned electrodes is applicable. The cells were tested under 0.1 C, 1 C and 2 C between 2.5 to 4.2V for prolonged cycling. FIGS. 7A-7C show the cycling performance comparisons between the REF and HPE using NCM-C full cell configurations at different rates. The HPE (NCM-C) exhibit superior rate performance than the REF, especially at 2 C rate, the HPE can deliver almost one-fold higher specific capacity than the REF. The cycling results from full cells suggest that the improvement in terms of rate capability is more evident in full cell configuration, where the electric field might influence the concentration polarization of anion.

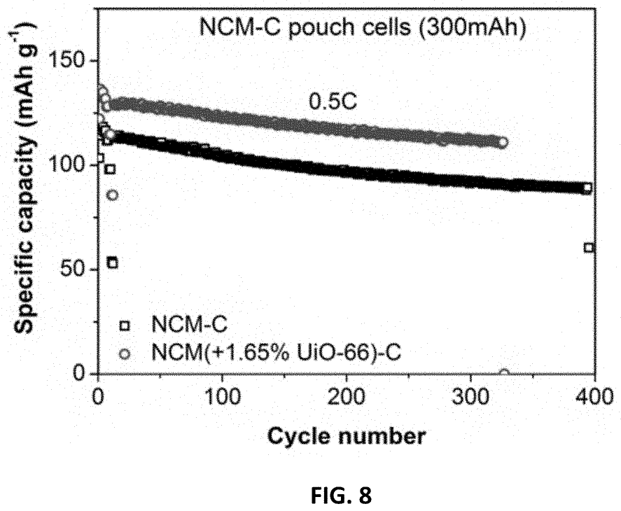

NCM-C full cells were further extended to punch cells configuration for practical application purposes. The designed capacity for punch cell is 300 mAh and corresponding mass loading of active material is identical to those electrodes used in coin cell. FIG. 8 shows the cycling performance comparisons between the REF and HPE using NCM-C pouch cell, where reproducible results were obtained in punch cells configuration in terms of rate and cycling performances.

Among other things, the advantages of MOF additives in electrodes of lithium-based battery according to embodiments of the invention are successfully demonstrated, while it is speculated that this is readily applicable to other alkali metal-based battery electrodes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrode used for a electrochemical device, comprising:
an electrochemical active material, a conductive additive, a binder and an electrode additive,
wherein the electrode additive comprises a metal organic framework (MOF) material defining a plurality of pores, the MOF being a class of crystalline porous scaffolds constructed from metal cluster nodes and organic linkers, wherein the MOF material is activated under vacuum at a temperature for a period of time.

2. The electrode of claim 1, wherein the MOF material comprises open metal sites (OMSs) that are corresponding to unsaturated metal centers created by activating pristine MOFs to remove guest molecules or partial ligands thereof.

3. The electrode of claim 1, wherein the MOF material is adapted such that a diameter of the pores provides a desired size to allow molecules of a liquid electrolyte to enter, and to accommodate salt anions in the liquid electrolyte.

4. The electrode of claim 3, wherein the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

5. The electrode of claim 4, wherein the MOF material comprises an zirconium-based MOF material with varied functional ligands comprising at least one of:
UiO-66 with the organic linkers of terephthalic acid;
UiO-67 with the organic linkers of 4,4′-biphenyldicarboxylic acid;
UiO-66-NH₂ with the organic linkers of 2-aminoterephthalic acid;
UiO-66-NO₂ with the organic linkers of 2-nitroterephthalic acid;
UiO-66-OH with the organic linkers of 2-hydroxyterephthalic acid; and
UiO-66-Br with the organic linkers of 2-bromoterephthalic acid.

6. The electrode of claim 3, wherein the MOF material further has surface defects for exposing more unsaturated metal centers to coordinate salt anions in the liquid electrolyte.

7. The electrode of claim 6, wherein sites of the surface defects of the MOF material are tunable by changing at least one of a metal vs ligand ratio, a synthetic temperature and the organic linkers.

8. The electrode of claim 1, wherein the electrode additive, the electrochemical active material, the conductive additive and the binder are mixed at a weight ratio in one or more solvents to form a slurry that is evenly casted on a current collector substrate, and the electrode is formed after the one or more solvents is evaporated.

9. The electrode of claim 8, wherein the electrode additive comprises an activated UiO-66, the electrochemical active material comprises LiNi_{0.33}Co_{0.33}Mn_{0.33}O₂ (NCM), the conductive additive comprises acetylene black (CB), the binder comprises polyvinylidene fluoride (PVDF), and the one or more solvents comprise N-Methyl-2-pyrrolidone (NMP), wherein the weight ratio of the activated UiO-66, NCM, CB and PVDF is 1.7:91.7:3.3:3.3.

10. The electrode of claim 8, wherein the electrode additive comprises an activated UiO-66, the electrochemical active material comprises graphite or LTO, the conductive additive comprises acetylene black (CB), the binder comprises polyvinylidene fluoride (PVDF), and the one or more solvents comprise N-Methyl-2-pyrrolidone (NMP), wherein the weight ratio of the activated UiO-66, graphite/LTO, CB and PVDF is 5:87:5:2.

11. An electrochemical device, comprising:
a positive electrode, a negative electrode, and a separator and an electrolyte disposed between the positive and negative electrodes,
wherein the electrolyte is a non-aqueous liquid electrolyte comprising a metal salt dissolved in an non-aqueous solvent; and
wherein at least one of the positive and negative electrodes is the electrode of claim 1, configured such that the activated MOF material is combined with and is soaked in the non-aqueous liquid electrolyte.

12. The electrochemical device of claim 11, wherein the non-aqueous solvent is adapted such that its polarity matches surface properties of the MOF material.

13. The electrochemical device of claim 12, wherein the non-aqueous solvent comprises one or more of ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, and cyclic ether compounds including at least one of tetrahydrofuran, 2-methyltetrahydrofuran, 1,3-dioxolane and dioxane.

14. The electrochemical device of claim 11, wherein the metal salt is adapted to have anions with desired sizes to ensure that the metal salt infiltrates into at least some of the pores of the activated MOF material and then becomes immobilized therein to form ionic conducting channels.

15. The electrochemical device of claim 14, wherein the anions are bound to metal atoms of the MOF material and positioned within the pores of the MOF material.

16. The electrochemical device of claim 14, wherein the metal salt comprises one or more of a lithium salt, a sodium salt, a magnesium salt, a zinc salt and an aluminum salt.

17. The electrochemical device of claim 16,
wherein the lithium salt comprises one or more of lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkyl sufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, and lithium chloride;
wherein the sodium salt comprises one or more of sodium trifluoromethanesulfonate, NaClO₄, NaPF₆, NaBF₄, NaTFSI (sodium(I) Bis(trifluoromethanesulfonyl)imide), and NaFSI (sodium(I) Bis(fluorosulfonyl)imide);
wherein the magnesium salt comprises one or more of magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), and Mg(FSI)₂ (magnesium(II) Bis(fluorosulfonyl)imide); and
wherein the zinc salt comprises one or more of zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide).

18. The electrochemical device of claim 11, wherein the separator is either ionic conductive or non-conductive, and comprises one or more of poly-propylene (PP), poly-ethylene (PE), glass fiber (GF), polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, and copolymers of them, perovskite lithium lanthanum titanate Li₃ₓLa_{(2/3-x)}M_{(1/3)-2x}TiO₃ (LLTO) with 0<x<0.16 and M=Mg, Al, Mn or Ru, lithium phosphorous oxynitride (LiPON, Li_{3.5}PO₃N_{0.5}), garnet oxide including Li₅La₃M₂O₁₂ with M=Nb or Ta, or cubic LLZO: Li₇La₃Zr₂O₁₂, and lithium sulphide.

19. The electrochemical device of claim 11, wherein the electrochemical device is a lithium battery,
wherein the positive electrode comprises one or more of LiCoO₂ (LCO), LiNiMnCoO₂ (NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide including LiNi_{0.5}Co_{0.15}Al_{0.05}O₂ or NCA, lithium vanadium oxide (LiV₂O₅), and Li₂MSiO₄ with M being composed of a ratio of Co, Fe, and/or Mn; and
wherein the negative electrode comprises one or more of lithium metal (Li), graphite, hard or soft carbon, graphene, carbon nanotubes, titanium oxide including at least one Li₄Ti₅O₁₂ and TiO₂, silicon (Si), tin (Sn), germanium (Ge), silicon monoxide (SiO), silicon oxide (SiO₂), tin oxide (SnO₂), and transition metal oxide including at least one of Fe₂O₃, Fe₃O₄, Co₃O₄ and MnₓO_{y}.

20. The electrochemical device of claim 11, wherein the electrochemical device is a sodium battery, a magnesium battery, or a zinc metal battery, wherein the positive electrode comprises one or more of NaMnO₂, NaFePO₄ and Na₃V₂(PO₄)₃ for the sodium battery, one or more of TiSe₂, MgFePO₄F, MgCo₂O₄ and V₂O₅ for the magnesium battery, or one or more of γ-MnO₂, ZnMn₂O₄, and ZnMnO₂ for the zinc battery.
